(19) United States
(12) Patent Application Publication
(10) Pub. No.: US 2023/0101405 A1
(43) Pub. Date: Mar. 30, 2023

(54) SYSTEMS AND METHODS OF CROSS-UTILITY CREDITING

(71) Applicant: Arcadia Power, Inc., Washington, DC (US)

(72) Inventors: Richard Caperton, Washington, DC (US); Max Minzner, Washington, DC (US); James Feinstein, Austin, TX (US)

(21) Appl. No.: 17/490,118

(22) Filed: Sep. 30, 2021

(51) Int. Cl. G06Q 50/06; G06Q 30/00; G06Q 30/04; G06Q 20/14; H02J 3/38; H02J 13/00

(52) U.S. Cl. CPC G06Q 50/06; G06Q 30/018; G06Q 30/04; G06Q 20/145; H02J 3/381; H02J 13/00006; H02J 2300/22

(57) ABSTRACT

Implementations of the disclosed subject matter may provide systems and methods of providing energy from a community solar energy generating system to a customer. The customer may have an account with a first energy utility, and the community solar energy generating system may be associated with a second energy utility. The first energy utility may be located in a first geographic area and both the community solar energy generating system and the second energy utility are located in a second geographic area. An allocation of energy produced by a community solar energy generating system may be determined for the customer based on energy usage based on the received utility account information, an energy output of the community solar energy generating system, and a credit rate. Information about the determined energy allocation and the credit rates may be shared between the second energy utility and the first energy utility.

### BACKGROUND

Presently, community solar energy generating systems are limited to providing credit for the energy they produce to customers and energy utilities that are located in the same territory. In part, this is because a community solar energy generating system is electrically interconnected to a particular energy utility that is local to the community solar energy generating system. That is, energy utility customers are only able to subscribe to community solar energy generating systems that are located in the same geographic area and/or territory as the energy utility and the customer's home and/or business.

### BRIEF SUMMARY

According to an implementation of the disclosed subject matter, a method may be provided that includes receiving, at a first server of a third-party aggregator of energy services, utility account information from a first energy utility for a customer. The first server may determine whether the customer is eligible to subscribe to a community solar energy generating system based on the received utility account information. The community solar energy generating system may be associated with a second energy utility. The first energy utility may be located in a first geographic area and both the community solar energy generating system and the second energy utility are located in a second geographic area. The method may include determining, at the first server, an allocation of energy produced by the community solar energy generating system when the customer is eligible and enrolled in a subscription to the community solar energy generating system. The allocation may be based on energy usage based on the received utility account information, an energy output of the community solar energy generating system, and a credit rate. The method may include transmitting, at the first server, information about the determined energy allocation and the credit rates between the second energy utility associated with the community solar energy generating system and the first energy utility.

According to an implementation of the disclosed subject matter, a system may be provided that includes a first server of a third-party aggregator of energy services to receive utility account information from a first energy utility for a customer The first server may determine whether the customer is eligible to subscribe to a community solar energy generating system based on the received utility account information. The community solar energy generating system may be associated with a second energy utility. The first energy utility may be located in a first geographic area and both the community solar energy generating system and the second energy utility are located in a second geographic area. The first server may determine an allocation of energy produced by the community solar energy generating system when the customer is eligible and enrolled in a subscription to the community solar energy generating system. The allocation may be based on energy usage based on the received utility account information, an energy output of the community solar energy generating system, and a credit rate. The first server may transmit information about the determined energy allocation and the credit rates between the second energy utility associated with the community solar energy generating system and the first energy utility.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIGS. 1-6 show an example method of providing credit for the energy to a customer of a first energy utility that is generated by a community solar energy generating system associated with a second energy utility, where the first energy utility is located in a first geographic area and both the community solar energy generating system and the second energy utility are located in a second geographic area according to implementations of the disclosed subject matter.

FIG. 7 shows a network arrangement of energy generating systems, servers, databases, and customer devices according to an implementation of the disclosed subject matter.

FIG. 8 shows a customer's device that may interface with the network arrangement shown in FIG. 7 according to an implementation of the disclosed subject matter.

FIGS. 9A-9B show example interactions between the solar energy generating system, the utilities, a third-party aggregator, and a subscriber according to implementations of the disclosed subject matter.

FIG. 10 shows an example database structure for a database according to an implementation of the disclosed subject matter.

### DETAILED DESCRIPTION

Community solar energy generating systems have traditionally been limited in geographic scope to providing energy to energy utilities and customers that are located in the same geographic area and/or territory. This traditional limitation has been, in part, due to community solar energy generating systems being electrically interconnected to a particular energy utility that they are geographically and/or territorially close to and also the operational complexity of providing credit for the generation of energy across utility territories. Not being located in the same area as the community solar energy generating system and associated energy utility has historically prevented potential customers from obtaining an allocation of credit for the energy from the community solar energy generating system, and prevented such customers from receiving credits on their electric bill to reflect the output of the community solar energy generating system.

Using implementations of the disclosed subject matter as described throughout, along with regulatory changes in certain states, customers of one energy utility may subscribe to a community solar energy generating system in a different utility territory and/or geographic area. This may be referred to as “cross utility crediting.” In implementations of the disclosed subject matter, data about a customer and a subscription to the community solar energy generating system may be transmitted between two energy utilities. For example, a first energy utility may be local to the customer, and a second energy utility may be associated with and located in the same geographic area as the community solar energy generating system. The collection and/or delivery of payments relating to the subscription, together with the corresponding allocation of energy credits, may be transmitted from one energy utility to the other so that the customer may subscribe to a community solar energy generating system that is outside of the geographic region of the customer while receiving energy credits with respect to the first energy utility (i.e., the customer's utility).

Implementations of the disclosed subject matter may collect data about the customer from the customer's account with a first energy utility that is located in a first geographic area, which may be the same geographic area as the customer. The collected data may be used to determine the customer's eligibility for a subscription to a community solar energy generating system that is associated with a second energy utility, where both the community solar energy generating system and the second energy utility are located in a second geographic location.

The customer's allocation of credit for energy for the subscription to the community solar energy generating system may be based on, for example, energy usage of the customer, the number of and energy usage of other subscribers to the community solar energy generating system, the energy output of the community solar energy generating system, and a predetermined credit rate (e.g., set by regulation, one or more energy utilities, or the like).

Information about the subscription and/or customer credit rates may be transmitted between the first energy utility of the customer (i.e., the energy utility in the same geographic area as the customer) and second energy utility (i.e., the energy utility associated with the community solar energy generating system). Credits may be provided to customers located in a different utility territory and/or geographic location from the community solar energy generating system. Credit rates may be based, for example, on an administratively determined value for the territory and/or geographic region of the community solar energy generating system. Payments collected from the first energy utility for remittance to the second energy utility that is associated with the community solar energy generating system may be transmitted between the first and second energy utilities.

In some implementations of the disclosed subject matter, a mix of customers located inside and outside the geographic area of the community solar energy generating system may be subscribed to the community solar energy generating system project.

Implementations of the disclosed subject matter may maximize the solar production and/or energy output from community solar energy generating systems by allowing such systems to be placed in different geographic areas. The different geographic regions may include, for example, different towns, cities, states, or the like. The community solar energy generating systems may be located in geographic areas where sunshine is more prevalent over a period of time (e.g., day, month, year, or the like) than where a customer and/or a customer's energy utility may be located. In another example, the community solar energy generating systems may be located in a geographic area where construction of such systems may be easier (e.g., based on land accessibility, land availability, labor availability and expertise, transportation of construction materials, or the like). Implementations of the disclosed subject matter may promote the development of community solar energy generating systems in different geographic locations, and may maximize the output of energy generated by a renewable energy source (i.e., solar energy).

Implementations of the disclosed subject matter may address the present energy system configurations, where energy utilities typically operate with different systems and procedures from one another. For example, there may be differences between billing practices, financial systems, payment terms, information technology (IT) systems, and internal policies. Currently, it is difficult to coordinate between utilities to apply bill credits from a community solar energy generating system in one energy utility area to a subscriber in a different energy utility area, and such energy utilities have very little incentive to coordinate with one another to apply such credits. One result of such arrangements is that it is currently not possible for an electricity customer to subscribe to community solar energy generating system that is in a different geographic area from the customer's local energy utility.

The inability to subscribe across utility areas creates an artificially segmented market, in which high electricity demand utility areas may not have sufficient community solar energy generating systems to provide electric power and/or bill credits to potential subscribers. In energy utility areas with significant energy supply from community solar energy generating systems, there may not be enough subscribers to allocate bill credits to. This may lead to undercompensation of energy generated by the community solar energy generating system.

Implementations of the disclosed subject matter may allocate credit for energy generated by solar energy generating systems to customers who may also be customers of a utility company that is in a different geographic area and/or territory than the solar energy generating system. That is, implementations of the disclosed subject matter described throughout address the present supply and demand mismatch for energy bill credits for energy generated by community solar energy generating systems.

Current systems result in energy generated being wasted, underutilized, and/or undercompensated for, and/or result economic waste. For example, such waste may be based on unmet demand, where residential and commercial subscribers are not able to obtain sufficient allocations of energy generated by community solar energy generating system to meet their energy needs. The waste may be based on energy supply with an insufficient number of subscribers to the community solar energy generating system, which results in the community solar energy generating system producing power for which there are not enough subscribers (e.g., generated energy may be undercompensated). That is, energy generated by the solar energy generating system may go underused and/or undervalued. In another example, there may be waste when community solar energy generating systems are not developed because there is not enough demand for the bill credits that would be generated by the community solar energy generating system because there are an insufficient number of customers in the geographic area where the community solar energy generating system would be developed.

These waste issues may have a significant economic impact. Community solar energy generating system projects are typically entitled to state-regulated revenue opportunities when the energy generated by the community solar energy generating system is allocated to subscribers in the specific month it is physically produced and provided to the electric power grid. If there is no subscriber to match with the community solar energy generating system's electricity generation, any excess energy generated by the community solar energy generating system would be considered “unsubscribed,” meaning that while the energy would still be generated and provided to the electrical power grid, the community solar energy generating system would not be able to participate in these incentives, and no customer would receive the economically-valuable bill credits. Energy being generated that is not allocated and used also results in in energy not being utilized (i.e., wasted energy), along with economic waste.

For example, these costs may include an undersubscribed community solar energy generating system which will not receive payment for all of the electricity it provides to the electrical power grid, or if it does receive payment, it will be from the energy utility at a significantly reduced rate than a subscriber to the community solar energy generating system would pay. In another example, bill credits for the community solar energy generating system, which have a defined economic value and would otherwise be provided to the subscriber, will be left “unassigned” and may be lost permanently. In another example, viable sites for community solar energy generating systems may not be developed because there is insufficient demand (i.e., insufficient offtake) to economically justify the solar developer's investment. In another example, a third-party aggregator of energy services may not be able to receive fees from solar developers for capacity which is not subscribed and/or which is not generated due to one or more of the foregoing issues.

A third-party aggregator of energy services may manage accounts of a customer for a utility (an electric utility) and/or a solar energy generating system. The third-party aggregator may manage billing the customer for the energy used by the customer from a first energy utility, along with credits from use of the community solar energy generating system, and/or payments to a second energy utility that is affiliated with the community solar energy generating system. The third-party aggregator may determine customers and allocation amounts for the energy generated by the solar energy generating system.

Implementations of the disclosed subject matter may control the sharing of customer data, distribution of payments, and/or credits across a plurality of energy utilities that may have different computer systems, data storage systems (e.g., databases), accounting stems, and/or business processes. In one implementation, a customer may have a utility account with a first energy utility that is in a first geographic area as the customer. A community solar energy generating system may generate electrical power, with the resulting credit to be provided to a customer of a second energy utility that is in a second geographic area as the community solar energy generating system. A third-party aggregator of energy services may prepare an invoice for the second energy utility. The invoice may be based on the generation from the community solar energy generating system, and the value of a community solar credit. The invoice may set forth the payment due to first energy utility, which is determined by the amount of credits (e.g., based on kWh of subscribed generation) multiplied by the value of the credits. The value of the credits may be based on an administratively determined value of community solar credits in the second geographic area of the community solar energy generating system. When the credit value varies depending on the subscriber, the third-party aggregator may calculate the credit owed based on the mix of subscribers who will ultimately receive credits. For example, a residential customer may receive a higher credit value than a commercial customer.

The amount on the invoice may be paid to the first energy utility, and will set forth the payment required to compensate the first energy utility for the credits it places on the customer's utility bill, where the customer has a subscription to the community solar energy generating system. The third-party aggregator of energy services may submit this invoice to the second energy utility.

The second energy utility may prepare a payment to the third-party aggregator of energy services. The payment may be accompanied by (a) the invoice prepared by the third-party aggregator of energy services, and (b) an allocation list containing identifying information for each subscriber's account and the proportion of community solar energy generating system output allocated to the customer (e.g., each subscriber). The allocation list may correspond to a subscriber list used to prepare the invoice for payment and may be based on the actual or projected electricity usage of such subscribers.

The third-party aggregator of energy services may pay the first energy utility, and the first energy utility may place bill credits on subscribers' bills in accordance with the allocation list and the total value of credits as represented by the invoice amount. The first energy utility may prepare a receipt showing the amount of credit applied to the subscriber.

The receipt and invoice may be compared. If there are differences between the receipt and the invoice, the first and second utilities may work directly or via third party (which may include the third-party aggregator of energy services) to reconcile the differences.

One or more of these operations may be accomplished by direct utility-to-utility relationships involving the exchange of data and funds. Given the nature of the utility industry, that process is likely to be less efficient and more expensive. The first and second energy utilities are likely to have different or incompatible business processes. For example, the second energy utility may prefer to make payments based on physical checks on a bi-monthly basis, while the first energy utility may prefer to receive payments via ACH (automated clearing house) transfers on a monthly basis. The third-party aggregator of energy services may match business processes between the first and second utilities, and may perform that function at a lower cost than either or both of the first and second energy utilities changing their business processes. Implementations of the disclosed subject matter address the aforementioned problems of the utility-to-utility arrangements by utilizing a third-party aggregator of energy services and/or a third-party resolver to reconcile and/or resolve differences (e.g., between payments, credits, and the like).

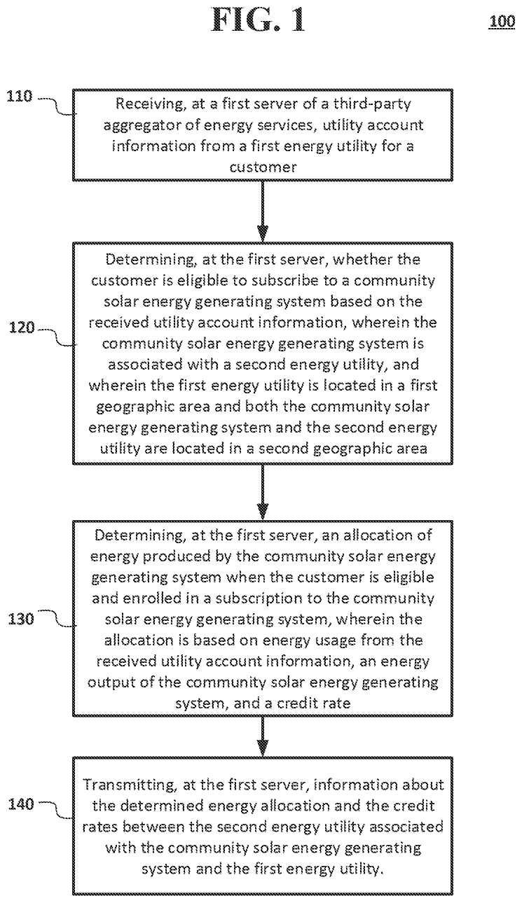

FIGS. 1-6 show an example method 100 of providing energy credits to a customer of a first energy utility that may be generated by a community solar energy generating system associated with a second energy utility, where the first energy utility is located in a first geographic area and both the community solar energy generating system and the second energy utility are located in a second geographic area according to implementations of the disclosed subject matter.

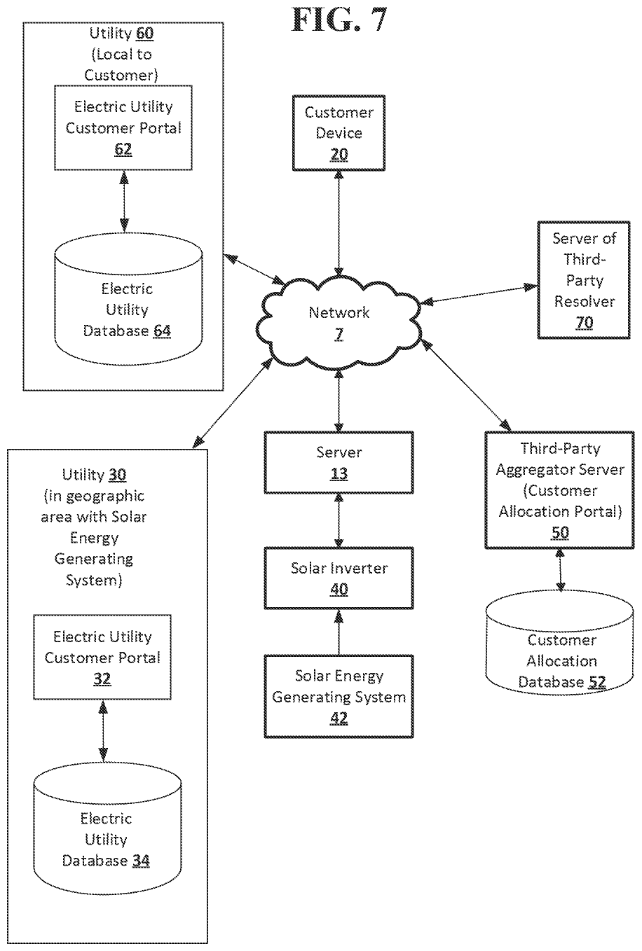

At operation 110 of method 100 shown in FIG. 1, a first server of a third-party aggregator of energy services may receive utility account information from a first energy utility for a customer. The first server may be third-party aggregator server 50 shown in FIG. 7, which may receive utility account information for a customer via network 7 from utility 60, which may be the first energy utility. The utility account information may include how much energy the customer uses (e.g., in kWh) over a predetermined period of time (e.g., one month, three months, six months, 9 months, and/or 1 year), an amount charged per kWh, an address and/or location of the customer, or the like. The first server of the third-party aggregator of energy services may communicate with one or more energy utilities and/or community solar energy generating systems to determine whether the customer may obtain a subscription with the community solar energy generating system. The first server of the third-party aggregator of energy services may manage billing the customer for the energy used by the customer from the first energy utility, along with credits from use of the community solar energy generating system, and/or payments to community solar energy generating system and/or the first energy utility (e.g., utility 60 shown in FIG. 7).

At operation 120, the first server may determine whether the customer is eligible to subscribe to a community solar energy generating system based on the received utility account information. The community solar energy generating system may include solar energy generating system 42, and, in some implementations, may also include solar inverter 40 and server 13 shown in FIG. 7. The community solar energy generating system may be associated with a second energy utility, which may be utility 30 shown in FIG. 7. The first energy utility (e.g., utility 60 shown in FIG. 7) may be located in a first geographic area, and both the community solar energy generating system (e.g., solar energy generating system 42) and the second energy utility (e.g., utility 30) may be located in a second geographic area.

That is, in operation 120, the first server may determine whether the customer is eligible to subscribe to a community solar energy generating system based on, for example, the amount of energy used by the customer, the times of peak energy usage, the times of reduced energy usage, and the like. The first server may determine whether the customer may benefit from a subscription to the community solar energy generating system, and whether the community solar energy generating system may be able to take on an additional subscriber based on the customer's energy usage.

At operation 130, the first server of the community solar energy generating system may determine an allocation of energy produced by the community solar energy generating system when the customer is eligible and enrolled in a subscription to the community solar energy generating system. The allocation of energy for the customer may be based on energy usage from the received utility account information, an energy output of the community solar energy generating system (e.g., solar energy generating system 42 shown in FIG. 7), and a credit rate. A credit rate may be a rate set by a regulation or entity to encourage the use of community solar energy generating system. The credit rate may be based on the subscriber (e.g., a residential customer could receive a higher credit value than a commercial customer in some jurisdictions), an administratively determined value, or the like.

At operation 140, the first server may transmit information about the determined energy allocation and the credit rates between the second energy utility (e.g., utility 30 shown in FIG. 7) associated with the community solar energy generating system (e.g., solar energy generating system 42 shown in FIG. 7) and the first energy utility (e.g., utility 60 shown in FIG. 7). That is, the first server may transmit information about the community solar energy generating system allocation of the customer (i.e., subscriber), and the credit rates for the customer to the first and second energy utilities.

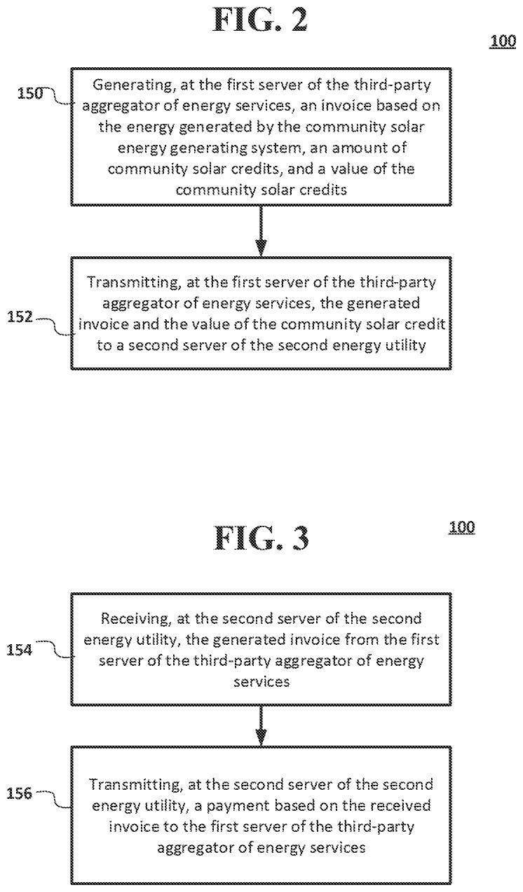

FIG. 2 shows additional operations of method 100 according to an implementation of the disclosed subject matter. At operation 150, the first server of the third-party aggregator of energy services (e.g., third-party aggregator server 50 shown in FIG. 7) may generate an invoice based on the energy generated by the community solar energy generating system (e.g., solar energy generating system 42), an amount of community solar credits, and a value of the community solar credits. In some implementations, the credit value may be based on the subscriber. For example, a residential customer could receive a higher credit value than a commercial customer in some jurisdictions. The invoice may be generated based on the energy generation from the community solar energy generating system and the value of a community solar credit in the second energy utility. The generated invoice may set forth the payment due to the community solar energy generating system. This may be determined based on the amount of credits (e.g., based on kWh of generation) multiplied by the value of the credits. For example, the value of the credits may be based on the administratively determined value of community solar credits in the community solar energy generating system territory and/or geographic area. In some implementations, the credit value may vary depending on the subscriber. For example, a residential customer may receive a higher credit value than a commercial customer. In some implementations, the first server may calculate a credit owed based on a mix of subscribers who may ultimately receive credits.

At operation 152, the first server of the third-party aggregator of energy services may transmit the generated invoice and the value of the community solar credit to a second server of the second energy utility. For example, the third-party aggregator server 50 shown in FIG. 7 may transmit the generated invoice and the value of the community solar credit to utility 30 via network 7.

FIG. 3 shows additional operations of method 100 that may be performed after the operations shown in FIG. 2 according to an implementation of the disclosed subject matter. At operation 154, the second server of the second energy utility (e.g., utility 30 shown in FIG. 7) may receive the generated invoice from the first server of the third-party aggregator of energy services (e.g., third-party aggregator server 50). At operation 156, the second server of the second energy utility (e.g., utility 60 shown in FIG. 7) may transmit a payment based on the received invoice to the first server of the third-party aggregator of energy services (e.g., the third-party aggregator server 50 shown in FIG. 7).

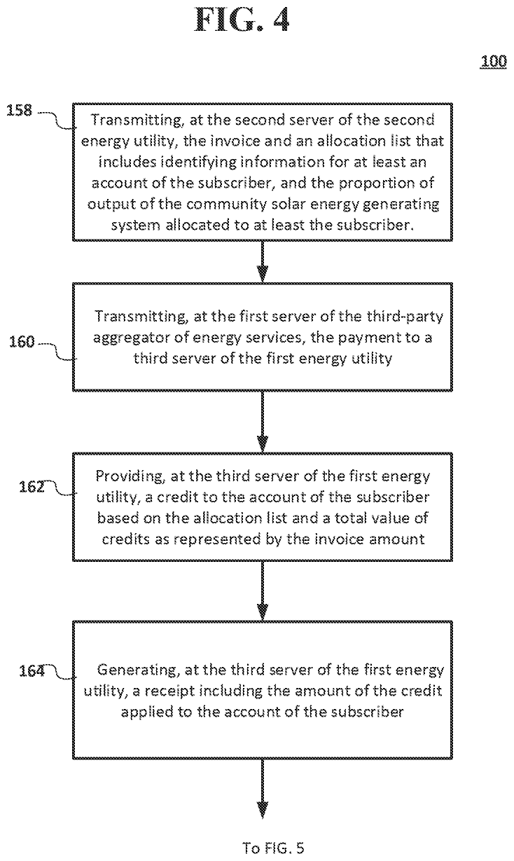

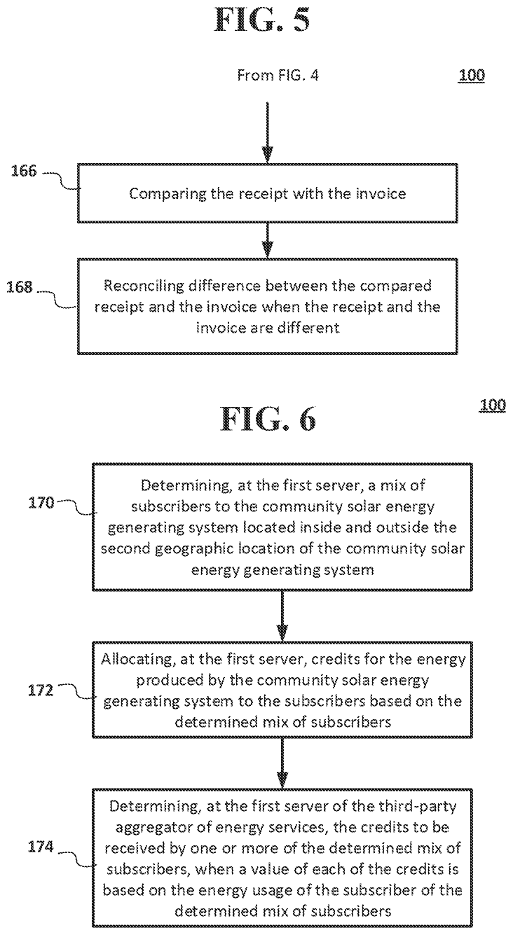

FIG. 4 shows example operations that may be performed after the operations of FIGS. 1-3 in connection with method 100 according to an implementation of the disclosed subject matter. At operation 158, the second server of the second energy utility (e.g., utility 30 shown in FIG. 7) may transmitting the invoice and an allocation list that includes identifying information for at least an account of the subscriber, and the proportion of output of the community solar energy generating system allocated to at least the subscriber. The transmitting operation 158 may be related to operation 156 of FIG. 3.

At operation 160, the first server of the third-party aggregator of energy services (e.g., third-party aggregator server 50 shown in FIG. 7) may transmit the payment to a third server of the first energy utility (e.g., utility 60 shown in FIG. 7). That is, the first server may transmit payment to the third server for the electricity provided by the first energy utility to the customer. As described above the first server may aggregate energy services from traditional energy utilities and community solar energy generating systems, so that the customer may receive a single bill and/or credits from different energy providers. In operation 160, the first server may provide payment to the third server based on the customer's energy usage, and may separately receive payment from the customer.

At operation 162, the third server of the first energy utility (e.g., utility 60 shown in FIG. 7) may provide a credit to the account of the subscriber (i.e., the subscriber of the community solar energy generating system) based on the allocation list and a total value of credits as represented by the invoice amount. The allocation list may identify energy allocation amounts for one or more subscribers to the community solar energy generating system.

At operation 164, the third server of the first energy utility (e.g., utility 60 shown in FIG. 7) may generate a receipt including the amount of the credit applied to the account of the subscriber. At operation 166 shown in FIG. 5, the receipt may be compared with the invoice, and at operation 168, a difference between the compared receipt and the invoice may be reconciled when the receipt and the invoice are different. In some implementations, the first server of the third-party aggregator of energy services (e.g., the third-party aggregator server 50 shown in FIG. 7) or a third-party resolver (e.g., server of a third-party resolver 70 shown in FIG. 7) may compare the receipt with the invoice. For example, there may be differences in the amount of credit applied, the amount of money received, or the like.

The differences between the invoice and the receipt may be reconciled by the first server of the third-party aggregator of energy services (e.g., the third-party aggregator server 50 shown in FIG. 7), the second server of the second energy utility (e.g., utility 30 shown in FIG. 7), a third server of the first energy utility (e.g., utility 60 shown in FIG. 7), a fourth server of the community solar energy generating system (e.g., server 13 shown in FIG. 7), and/or a fifth server of a third-party resolver (e.g., server of the third-party resolver 70 shown in FIG. 7).

FIG. 6 shows example operations of method 100 according to an implementation of the disclosed subject matter. At operation 170, the first server of the third-party aggregator of energy services (e.g., the third-party aggregator server 50 shown in FIG. 7) may determine a mix of subscribers to the community solar energy generating system (e.g., community solar energy generating system 42 shown in FIG. 7) located inside and outside the second geographic location of the community solar energy generating system. That is, the first server may determine a mix of customers located inside and outside the geographic area and/or territory of the community solar energy generating system to optimize the economic efficiency of the project. At operation 172, the first server of the third-party aggregator of energy services may allocate the credits for the energy produced by the community solar energy generating system to the subscribers based on the determined mix of subscribers. For example, if there are 60 subscribers in the second geographic area and 30 subscribers in the first geographic area, the first server may allocate energy produced by the community solar energy generating system to this mix of subscribers in the first and second geographic areas. At operation 174, the first server of the third-party aggregator of energy services may determine credits to be received by one or more of the determined mix of subscribers, when a value of each of the credits is based on the energy usage of the subscriber of the determined mix of subscribers. Credits may be provided by the first server based on the determined credits for the mix of subscribers.

FIG. 7 shows a network arrangement of energy generating systems, servers, databases, and customer devices according to an implementation of the disclosed subject matter. A utility 30 (i.e., an electric utility) may generate electricity to be provided to one or more customers via a power grid. The utility 30 may include a server that provides an electric utility customer portal 32, which may allow customers and/or a customer allocation portal of the third-party aggregator server 50 to access account information with the utility 60. Account information may include, for example, utility bills, payment information, amount of energy used, address and contact information, and the like. The server of the utility 30 and/or utility 60 may be one or more hardware servers and or a cloud server. The server of the utility 60 that provides the electric utility customer portal 62 may be communicatively coupled to an electric utility database 64, which may store, among other things, historic utility bill statements, address information, account information, and the like for one or more customers. The utility 60 may be communicatively coupled to the server 13 via communications network 7. The utility 60 may be local to the customer (e.g., customer device 20), and may be in a different geographic area from the utility 30 and the solar energy generating system 42. The server of the utility 30 that provides the electric utility customer portal 32 may be communicatively coupled to an electric utility database 34, which may store, among other things, historic utility bill statements, address information, account information, and the like for one or more customers. The utility 30 may be communicatively coupled to the server 13 via communications network 7.

The server 13 may be one or more hardware servers, cloud servers or the like, and may be connected to a solar inverter 40, and a solar energy generating system 42 (i.e., the community solar energy generating system). The solar inverter 40 may convert direct current (DC) output of a photovoltaic (PV) solar panels of the solar energy generating system 42 into an alternating current (AC) that may be provided into a commercial electrical grid, which may be the same power grid that the utility 30 is connected to. The solar inverter 40 may include a server (e.g., one or more hardware servers, a cloud server, or the like) to provide data logging and/or an application program interface (API). The data logger may determine the amount of energy generated by the solar energy generating system 42 over a predetermined period of time (e.g., one or more hours of the day, the amount of energy generated for one or more months, the amount of energy generated over a year, or the like). The API may provide at least a portion of the logged data to the server 13, the third-party aggregator server 50, a server of a third-party resolver 70, and/or the customer device 20, and may be used to update (e.g., add, remove, or the like) customers that may be subscribed to the community solar energy generating system.

Customer allocation portal of the third-party aggregator server 50 may be communicatively coupled to customer allocation database 52. The customer allocation portal of the third-party aggregator server 50 may manage subscriptions, credits, and /or billing for a customer having a subscription with the community solar energy generating system, a utility account, and/or other product and/or service accounts. The allocation portal of the third-party aggregator server 50 may be accessed, for example, by the server 13 to set and/or adjust an allocation of the energy for a customer that is subscribed to the community solar energy generating system. The set and/or adjusted allocation for a customer may be stored in the customer allocation database 52.

The utility 30, the utility 60, the server 13, the server of the third-party resolver 70, the third-party aggregator 50, and a customer device 20 (described below in connection with FIG. 7) may be communicatively connected via communications network 7. The network 7 may be a local network, wide-area network, the Internet, or any other suitable communication network or networks, and may be implemented on any suitable platform including wired and/or wireless networks.

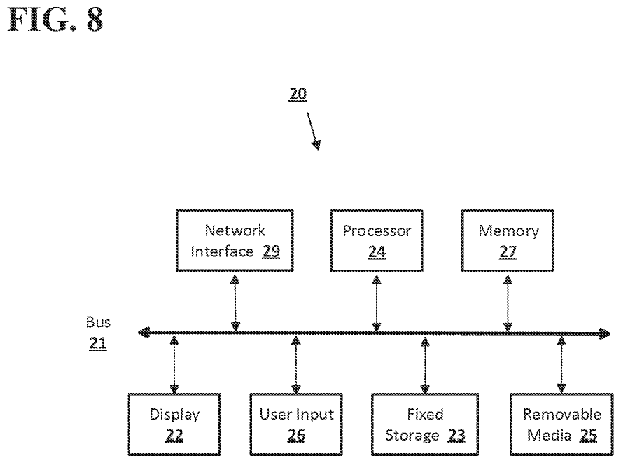

FIGS. 7-8 show an example customer device 20 that may a desktop or laptop computer, or a mobile computing device such as a smart phone, tablet, wearable computing device, or the like. In some implementations, the device 20 may be used to manage a subscription to the community solar energy generating system, to manage an account with the utility 60, and/or receive billing information and/or credits from the third-party aggregator server 50. The device 20 may include a bus 21 which interconnects major components of the device 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically, RAM is the main memory into which an operating system and application programs are loaded. A ROM or flash memory component can contain, among other code, the Basic Input-Output system (BIOS) which controls basic hardware operation such as the interaction with peripheral components. Applications resident with the device 20 are generally stored on and accessed via a computer readable medium, such as a hard disk drive (e.g., fixed storage 23), an optical drive, floppy disk, or other storage medium.

The fixed storage 23 may be integral with the device 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner to those shown in FIGS. 7-8 (e.g., sensors, energy use monitors, and the like). Conversely, all the components shown in FIG. 8 need not be present to practice the present disclosure. The components can be interconnected in different ways from that shown. The operation of the device 20 such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

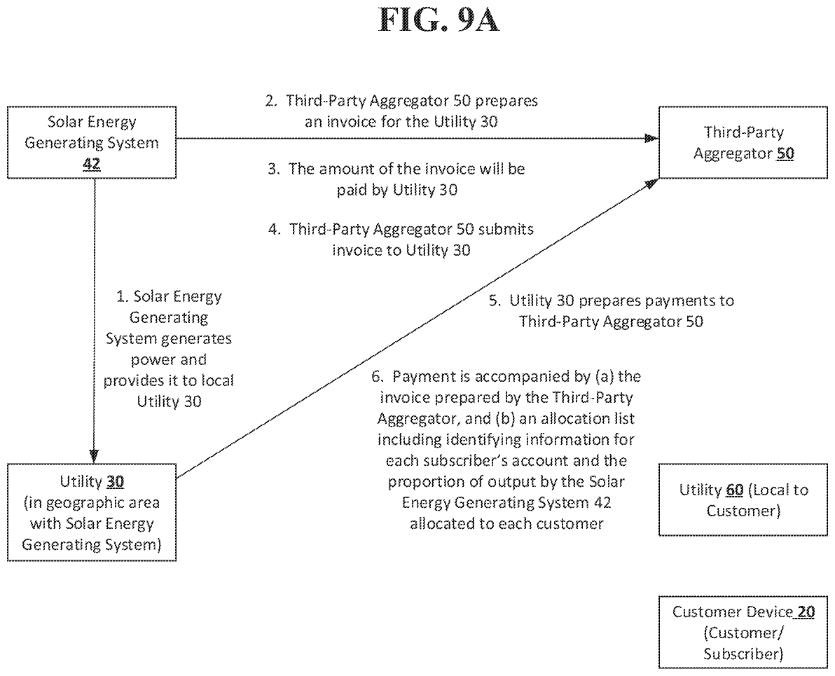

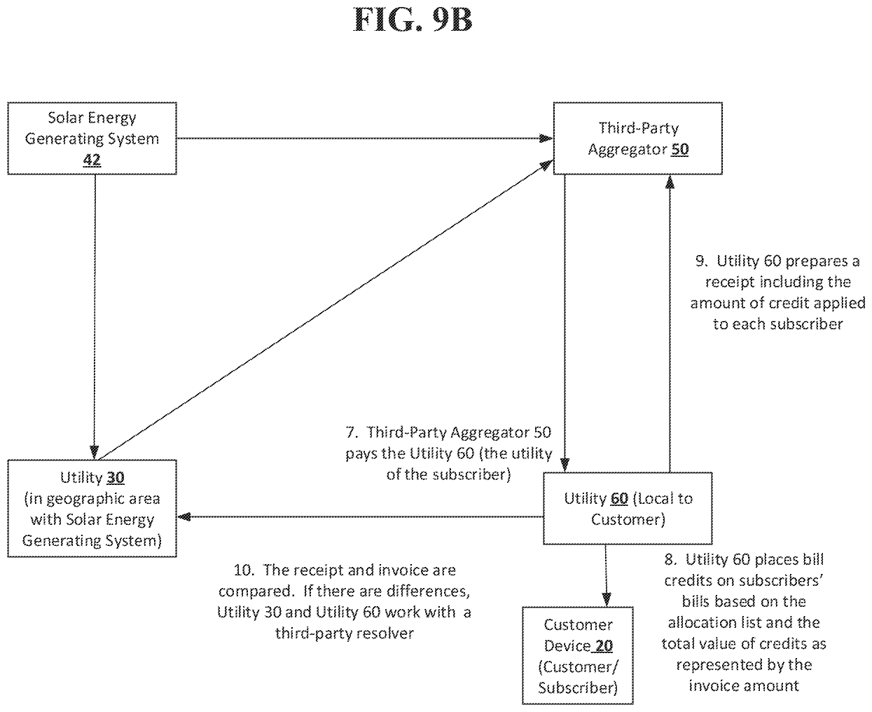

FIGS. 9A-9B show example interactions between the solar energy generating system, the utilities, a third-party aggregator, and a subscriber based on the method 100 shown in FIGS. 1-6 and the system shown in FIGS. 7-8 according to implementations of the disclosed subject matter.

As shown in FIG. 9A, the solar energy generating system 42 may first generate power and provide it to utility 30, which may be in the geographic area with the solar energy generating system 42 (e.g., as shown at item #1). For example, the solar energy generating system 42 may generate 10,000 kWh of power at a local credit rate of $0.10/kWh. In this example, such generation may provide $1,000 of bill credits to the applicable subscribers.

Second, the third-party aggregator 50 may prepare an invoice for the utility 30 (e.g., as shown at item #2). Continuing the example above, the third-party aggregator 50 may prepare a $1,000 invoice to the be paid by the utility 30 which may be utility that is local to and/or is in the geographic area with the solar energy generating system 42. The amount of the invoice is to be paid by utility 30, as shown at item #3 of FIG. 9A. That is, the utility 30 may pay $1,000 to the third-party aggregator 50.

The third-party aggregator 50 may submit the invoice to the utility 30 (as shown in item #4), which may be in the geographic area with the solar energy generating system 42. Continuing the example above, the invoice may be the prepared invoice for $1000. At item #5 of FIG. 9A, the utility 30 may prepare payments to the third-party aggregator 50. Continuing the example, the utility 30 may pay $1,000 to the third-party aggregator. The payment by the utility 30 to the third-party aggregator 50 may be accompanied by the invoice prepared by the third-party aggregator 50, and an allocation list that may include identifying information for one or more subscriber accounts (e.g., each subscriber account) and the proportion of the power output by the solar energy generating system 42 at item #6 shown in FIG. 9A.

FIG. 9B shows additional operations between the solar energy generating system, the utilities, a third-party aggregator, and a subscriber based on the method 100 shown in FIGS. 1-6 and the system shown in FIG. 7 according to implementations of the disclosed subject matter. At item #7, the third-party aggregator 50 may pay the utility 60 (which may be local to the customer and/or subscriber). Continuing the example above, the third-party aggregator 50 may pay $1,000 to the utility 60.

The utility 60 may place bill credits on the bills of one or more subscribers based on the allocation list received from the third-party aggregator 50 and the total value of credit as represented by invoice amount at item #8. FIG. 9B shows that utility 60 may prepare a receipt including the amount of credit to be applied to one or more subscribers (e.g., each subscriber) at item #9. Continuing the example from above, when utility 60 is paid $1,000 by the third-party aggregator, the utility 60 may prepare the receipt for the payment and the amount of credit to be applied to the subscribers.

At item #10 of FIG. 9B, the receipt (i.e., from the utility 60) and the invoice (e.g., that is prepared by the third-party aggregator 50) are compared. If there are differences between the receipt and the invoice, the utility 30 and the utility 60 may resolve the differences between themselves, or a third-party resolver (e.g., server of third-party resolver 70 shown in FIG. 7 and described above) may resolve the differences.

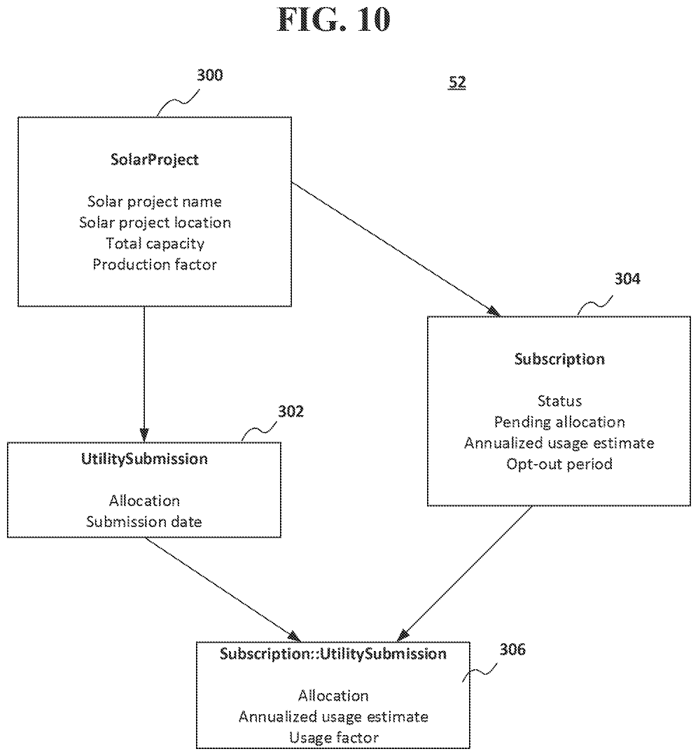

FIG. 10 shows a management data model that is stored in a database (e.g., customer allocation database 52 shown in FIG. 7) to track submission of customer allocations to a utility (e.g., utility 30 and/or utility 60 shown in FIG. 7) and/or rolling allocations by the customer allocation portal of the third-party aggregator server 50. The data structure 300 (i.e., SolarProject) may be for a solar energy project (i.e., a community solar energy generating system to be built or presently in operation, such as solar energy generating system 42 shown in FIG. 7), that may include the name of the project, the location of the project, the total energy-generating capacity of the project, and a production factor. The production factor may be a measure of how much energy is generated per unit of system capacity, and may be expressed in kWh/kW (e.g., where kWh is the energy output, and kW is the capacity). The data structure 302 (i.e., UtilitySubmission) may include an energy allocation for the solar energy project (e.g., a community solar energy generating system), and a submission date of the allocation to a utility (e.g., utility 30 and/or utility 60 shown in FIG. 7). The data structure 304 (i.e., Subscription) may include a status of a customer (e.g., active, awaiting allocation, discontinued service, or the like), a pending energy allocation amount of the customer, an annualized usage estimate (e.g., an estimate historic energy usage rate), and a length of an opt-out period (e.g., the length of time that the customer has to respond to a notification to accept or decline to receive energy generated by the community solar energy generating system). The data structure 306 (i.e., Subscription::UtilitySubmission) may include the determined allocation of energy for the customer, the annualized usage estimate of energy usage for the customer, and a usage factor (as described above).

In some implementations, the customer allocation portal of the third-party aggregator server 50 shown in FIG. 7 may transmit a list of the one or more of the plurality of customers and the respective allocations of energy to a utility (e.g., utility 30 shown in FIG. 7). The utility may assign an allocation of credit for energy for each of the one or more of the plurality of customers based on the transmitted allocations from the customer allocation portal of the third-party aggregator server 50. The allocations for each customer may be stored in customer allocation database 52 shown in FIG. 7.

The customer allocation portal of the third-party aggregator server 50 may dynamically track credit for energy allocation to one or more of the plurality of customers. The customer allocation portal of the third-party aggregator server 50 may transmit, via the communications network (e.g., communications network 7 shown in FIG. 7), the dynamically tracked energy usage for each of the one of more of the plurality of customers for display.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving, at a first server of a third-party aggregator of energy services, utility account information from a first energy utility for a customer;
determining, at the first server, whether the customer is eligible to subscribe to a community solar energy generating system based on the received utility account information, wherein the community solar energy generating system is associated with a second energy utility, and wherein the first energy utility is located in a first geographic area and both the community solar energy generating system and the second energy utility are located in a second geographic area;
determining, at the first server, an allocation of energy produced by the community solar energy generating system when the customer is eligible and enrolled in a subscription to the community solar energy generating system, wherein the allocation is based on energy usage from the received utility account information, an energy output of the community solar energy generating system, and a credit rate; and
transmitting, at the first server, information about the determined energy allocation and the credit rates between the second energy utility associated with the community solar energy generating system and the first energy utility.

2. The method of claim 1, further comprising:
generating, at the first server of the third-party aggregator of energy services, an invoice based on the energy generated by the community solar energy generating system, an amount of community solar credits, and a value of the community solar credits; and
transmitting, at the first server of the third-party aggregator of energy services, the generated invoice and the value of the community solar credit to a second server of the second energy utility.

3. The method of claim 2, further comprising:
receiving, at the second server of the second energy utility, the generated invoice from the first server of the third-party aggregator of energy services; and
transmitting, at the second server of the second energy utility, a payment based on the received invoice to the first server of the third-party aggregator of energy services.

4. The method of claim 3, wherein the transmitting further comprises:
transmitting, at the second server of the second energy utility, the invoice and an allocation list that includes identifying information for at least an account of the subscriber, and the proportion of output of the community solar energy generating system allocated to at least the subscriber.

5. The method of claim 4, further comprising:
transmitting, at the first server of the third-party aggregator of energy services, the payment to a third server of the first energy utility.

6. The method of claim 5, further comprising:
providing, at the third server of the first energy utility, a credit to the account of the subscriber based on the allocation list and a total value of credits as represented by the invoice amount.

7. The method of claim 6, further comprising:
generating, at the third server of the first energy utility, a receipt including the amount of the credit applied to the account of the subscriber.

8. The method of claim 7, further comprising:
comparing the receipt with the invoice; and
reconciling difference between the compared receipt and the invoice when the receipt and the invoice are different.

9. The method of claim 8, wherein the differences are reconciled by at least one selected from the group consisting of: the first server of the third-party aggregator of energy services, the second server of the second energy utility, a third server of the first energy utility, a fourth server of the community solar energy generating system, and a fifth server of a third-party resolver.

10. The method of claim 1, further comprising:
determining, at the first server, a mix of subscribers to the community solar energy generating system located inside and outside the second geographic location of the community solar energy generating system; and
allocating, at the first server, credits for the energy produced by the community solar energy generating system to the subscribers based on the determined mix of subscribers.

11. The method of claim 10, further comprising:
determining, at the first server of the third-party aggregator of energy services, credits to be received by one or more of the determined mix of subscribers, when a value of each of the credits is based on the energy usage of the subscriber of the determined mix of subscribers.

12. A system comprising:
a first server of a third-party aggregator of energy services to:
receive utility account information from a first energy utility for a customer;
determine whether the customer is eligible to subscribe to a community solar energy generating system based on the received utility account information, wherein the community solar energy generating system is associated with a second energy utility, and wherein the first energy utility is located in a first geographic area and both the community solar energy generating system and the second energy utility are located in a second geographic area;
determine an allocation of energy produced by the community solar energy generating system when the customer is eligible and enrolled in a subscription to the community solar energy generating system, wherein the allocation is based on energy usage from the received utility account information, an energy output of the community solar energy generating system, and a credit rate; and
transmit information about the determined energy allocation and the credit rates between the second energy utility associated with the community solar energy generating system and the first energy utility.

13. The system of claim 12, wherein the first server of the third-party aggregator of energy services:
generates an invoice based on the energy generated by the community solar energy generating system, an amount of community solar credits, and a value of the community solar credits, and
transmits the generated invoice and the value of the community solar credit to a second server of the second energy utility.

14. The system of claim 13, further comprising:
a second server of the second energy utility to:
receive the generated invoice from the first server of the third-party aggregator of energy services; and
transmit a payment based on the received invoice to the first server for the third-party aggregator of energy services.

15. The system of claim 14, wherein the second server of the second energy utility transmits the invoice and an allocation list that includes identifying information for at least an account of the subscriber, and the proportion of output of the community solar energy generating system allocated to at least the subscriber.

16. The system of claim 15, wherein the first server of the third-party aggregator of energy services transmits the payment to a third server of the first energy utility.

17. The system of claim 16, wherein the third server of the first energy utility provides a credit to the account of the subscriber based on the allocation list and a total value of credits as represented by the invoice amount.

18. The system of claim 17, wherein the third server of the first energy utility generates a receipt including the amount of the credit applied to the account of the subscriber.

19. The system of claim 18, wherein at least one selected from the group consisting of: the first server of the third-party aggregator of energy services, the second server of the second energy utility, a third server of the first energy utility, a fourth server of the community solar energy generating system, and a fifth server of a third-party resolver compares the receipt with the invoice, and reconciles a difference between the compared receipt and the invoice when the receipt and the invoice are different.

20. The system of claim 19, wherein the first server of the third-party aggregator of energy services:
determines a mix of subscribers to the community solar energy generating system located inside and outside the second geographic location of the community solar energy generating system; and
allocates the energy produced by the community solar energy generating system to the subscribers based on the determined mix of subscribers.

21. The system of claim 20, wherein the first server of the third-party aggregator of energy services determines credits to be received by one or more of the determined mix of subscribers, when a value of each of the credits is based on the energy usage of the subscriber of the determined mix of subscribers.
